(19) United States
(12) Patent Application Publication
(10) Pub. No.: US 2026/0367439 A1
(43) Pub. Date: Nov. 19, 2026

(54) ELECTRO-OPTICAL APPARATUS AND ELECTRONIC INSTRUMENT

(71) Applicant: SEIKO EPSON CORPORATION, Tokyo (JP)

(72) Inventor: Yuki GOTO, CHITOSE-SHI (JP)

(73) Assignee: SEIKO EPSON CORPORATION, Tokyo (JP)

(21) Appl. No.: 19/674,110

(22) Filed: May 11, 2026

(30) Foreign Application Priority Data
May 14, 2025 (JP) 2025-081111

(51) Int. Cl. G02F 1/1333; G02F 1/1339; G03B 21/00

(52) U.S. Cl. CPC G02F 1/133368; G02F 1/1339; G03B 21/006

(57) ABSTRACT

An electro-optical apparatus includes: a first substrate; a second substrate; and a conduction member provided between the first substrate and the second substrate, and the first substrate includes a first electrode film having an opening, an insulating member having a first recess provided in a region inside the opening in a plan view, and a conduction terminal portion provided along the first recess of the insulating member and electrically coupled to the conduction member.

### CROSS-REFERENCE TO RELATED APPLICATION

The present application is based on, and claims priority from JP Application Serial Number 2025-081111, filed May 14, 2025, the disclosure of which is hereby incorporated by reference herein in its entirety.

### BACKGROUND

### 1. Technical Field

The present disclosure relates to an electro-optical apparatus and an electronic instrument.

### 2. Related Art

As an electro-optical apparatus, there is, for example, a known liquid crystal apparatus used as a light valve of a projector. In the liquid crystal apparatus, a sealant and a conduction member are disposed between a pair of substrates, and a liquid crystal layer is disposed in a space surrounded by the sealant.

In the liquid crystal apparatuses disclosed in JP-A-11-109886 and JP-A-2021-001966, a pair of substrates are electrically continuous with each other via a conduction member. In the liquid crystal apparatus disclosed in JP-A-11-167125, to adjust a cell gap that is the gap between a pair of substrates, spacers that make the cell gap constant are mixed in a sealant that bonds the substrates to each other.

JP-A-11-109886, JP-A-2021-001966, and JP-A-11-167125 are examples of the related art.

There are various cell gaps required in liquid crystal apparatuses. In each of the liquid crystal apparatuses of the related art, it is necessary to change the type of the conduction member in accordance with the requirement of the cell gap, it requires time and effort to prepare multiple types of conduction members in accordance with the cell gap, resulting in a problem of an increase in cost.

### SUMMARY

An electro-optical apparatus according to a first aspect of the present disclosure includes: a first substrate; a second substrate; and a conduction member provided between the first substrate and the second substrate, and the first substrate includes a first electrode film having an opening, an insulating member having a first recess provided in a region inside the opening in a plan view, and a conduction terminal portion provided along the first recess of the insulating member and electrically coupled to the conduction member.

An electronic instrument according to a second aspect of the present disclosure includes the electro-optical apparatus according to the aspect described above.

### BRIEF DESCRIPTION OF THE DRAWINGS

FIG. 1 is a schematic configuration diagram of a liquid crystal apparatus according to an embodiment.

FIG. 2 is a cross-sectional view of the liquid crystal apparatus taken along the line II-II shown in FIG. 1.

FIG. 3 is a cross-sectional view of the liquid crystal apparatus taken along the line III-III shown in FIG. 1.

FIG. 4 is a plan view showing a planar configuration of an inter-substrate conduction portion.

FIG. 5 shows the step of forming a recess.

FIG. 6 is a cross-sectional view of a liquid crystal apparatus of a second embodiment.

FIG. 7 is a schematic view of a projector as an example of an electronic instrument according to a third embodiment.

### DESCRIPTION OF EMBODIMENTS

Embodiments of the present disclosure will be described below in detail with reference to the drawings. In the drawings used in the description below, a characteristic portion is enlarged for convenience in some cases for clarity of the characteristic thereof, and the dimension ratio and other factors of each element are therefore not always equal to actual values.

### First embodiment

In the present embodiment, an active-drive-type liquid crystal apparatus including thin film transistors (hereinafter abbreviated to "TFTs") as transistors on a pixel basis is presented by way of example of an electro-optical apparatus. The liquid crystal apparatus is suitable, for example, as a light modulator (liquid crystal light valve) of a projector as an electronic instrument described later.

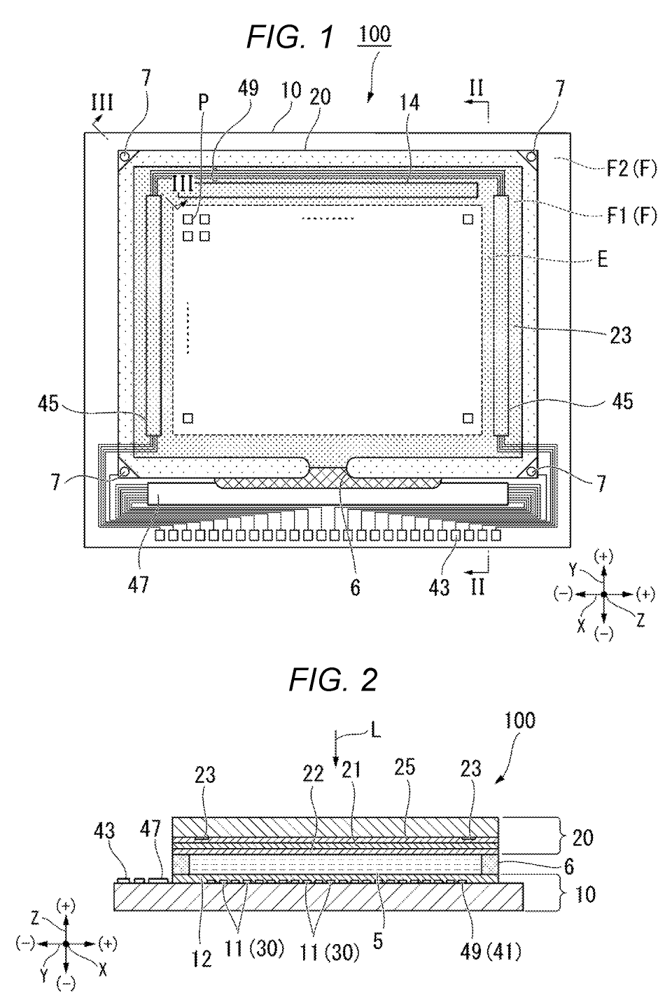

FIG. 1 is a schematic configuration diagram of a projector according to the present embodiment. FIG. 2 is a cross-sectional view of a liquid crystal apparatus 100 taken along the line II-II shown in FIG. 1.

The liquid crystal apparatus 100 according to the present embodiment includes an element substrate (first substrate) 10, a counter substrate (second substrate) 20 disposed so as to face the element substrate 10, a liquid crystal layer (electro-optical layer) 5 containing a liquid crystal material interposed between the element substrate 10 and the counter substrate 20, and inter-substrate conduction portions 7 each including a conduction member 17, which causes the element substrate 10 and the counter substrate 20 to be electrically continuous with each other, as shown in FIGS. 1 and 2.

In the following description, an XYZ coordinate system shown in the drawings is used in some cases to describe the arrangement of members of the liquid crystal apparatus 100. One direction along the X-axis is referred to as a +X direction, and the direction opposite the +X direction is referred to as a −X direction. Similarly, one direction along the Y-axis is referred to as a +Y direction, and the direction opposite the +Y direction is referred to as a −Y direction. One direction along the Z-axis is referred to as a +Z direction, and the direction opposite the +Z direction is referred to as a −Z direction. A plane containing the X-axis and the Y-axis may be referred to as an "XY plane", a plane containing the X-axis and the Z-axis may be referred to as an "XZ plane", and viewing the XY plane in the direction of a normal to the element substrate 10 and along the Z-axis may be referred to as a "plan view".

In the plan view, the width of the element substrate 10 along the X-axis and the width thereof along the Y-axis are greater than those of the counter substrate 20. The element substrate 10 and the counter substrate 20 are bonded to each other in the direction of the Z-axis via a sealant 6 disposed along the outer edge of the counter substrate 20. A liquid crystal material having positive or negative dielectric anisotropy is encapsulated in the space surrounded by the element substrate 10, the counter substrate 20, and the sealant 6 to form the liquid crystal layer 5. The sealant 6 is, for example, an adhesive such as a thermosetting, photocurable, or electron-beam-curable epoxy resin. Spacers that are not shown may be mixed in the sealant 6 to keep the distance between the pair of substrates constant.

In the plan view, a display region E having multiple pixels P is provided in a region inside the sealant 6. The multiple pixels P are arranged in a matrix along the X-axis and the Y-axis. In the plan view, a region outside the display region E is a peripheral region F. In the plan view, dummy pixels that are not shown are provided in a first peripheral region F1 between the sealant 6 and the display region E out of the peripheral region F. The first peripheral region F1 surrounds the display region E in the XY plane.

In the plan view, a light blocking member 23, which surrounds the display region E, is provided in the first peripheral region F1. For example, an inspection circuit 14 is provided in a region of the first peripheral region F1 that is the region between the display region E and the sealant 6 that forms one side extending along the X-axis and disposed on the +Y side in the direction of the Y axis. Scanning line drive circuits 45 are provided in regions of the first peripheral region F1 that are the region between the display region E and the sealant 6 that forms a side extending along the Y-axis and the region between the display region E and the sealant 6 that forms another side extending along the Y-axis. Multiple wires 49, which couple the two scanning line drive circuits 45 to each other, are disposed in a region of the first peripheral region F1 that is the region between the sealant 6 and the inspection circuit 14.

Multiple external coupling terminals 43 are provided in a second peripheral region F2, which is a portion of the peripheral region F of the element substrate 10 and is outside the sealant 6. For example, the multiple external coupling terminals 43 are disposed at intervals along the X-axis in the second peripheral region F2 extending along the X-axis and located on the −Y side in the Y-axis. In the plan view, in the second peripheral region F2, a data line drive circuit 47 is provided between the region where the multiple external coupling terminals 43 are disposed and the sealant 6 extending along the X-axis.

The wires 49 are linked to the data line drive circuit 47 and the scanning line drive circuits 45, and are coupled to the multiple external coupling terminals 43. Note that the inspection circuit 14 may be disposed in a region different from the region described above, that is, the region between the display region E and the sealant 6 that forms one side extending along the X-axis and disposed on the +Y side in the direction of the Y axis.

The element substrate 10 is provided with thin film transistors 30, the inspection circuit 14, the wires 49, and an alignment film 12 at a surface facing the liquid crystal layer 5, as shown in FIG. 2. The thin film transistors 30 are each a switching element provided for each of the pixels P. The thin film transistors 30 and pixel electrodes 11 are elements of the pixels P. The element substrate 10 includes the pixel electrodes 11, the thin film transistors 30, the wires 49, and the alignment film 12, and the elements described above and the inspection circuit 14 form the element substrate 10.

The counter substrate 20 is provided with the light blocking member 23, an insulating layer 25, a counter electrode (common electrode) 21, and an alignment film 22 at a surface facing the liquid crystal layer 5. The insulating layer 25 covers the light blocking member 23. The counter electrode 21 is disposed as a common electrode provided so as to cover the insulating layer 25. The alignment film 22 covers the counter electrode 21. The counter substrate 20 includes the light blocking member 23, the counter electrode 21, and the alignment film 22, and the elements described above and the insulating layer 25 form the counter substrate 20.

In the plan view as shown in FIG. 1, the scanning line drive circuits 45 and the inspection circuit 14 overlap with the light blocking member 23. The light blocking member 23 functions as a light blocker. Incident light L is output from a light source apparatus that is not shown, and enters the liquid crystal apparatus 100 via the counter substrate 20 along the −Y direction. The light blocking member 23 blocks the incident light L so as not to enter peripheral circuits, such as the scanning line drive circuits 45. Providing the light blocking member 23 prevents malfunction of the peripheral circuits. The light blocking member 23 blocks unwanted stray light so as not to enter the display region E. Providing the light blocking member 23 suppresses a decrease in contrast in the liquid crystal apparatus 100.

The inter-substrate conduction portions 7 are provided at the four corners of the counter substrate 20 in the plan view, and cause wiring portions 40, which will be described later and are provided at the element substrate 10, to be electrically continuous with the counter electrode 21, which is provided at the counter substrate 20. In other words, the element substrate 10 and the counter substrate 20 are electrically coupled to each other via the four inter-substrate conduction portions 7. The configuration of the inter-substrate conduction portions 7 will be described later.

The pixel electrodes 11 and the counter electrode 21 are each configured with a transparent conductive film made, for example, of indium tin oxide (ITO) or indium zinc oxide (IZO). The material of the alignment films 12 and 22 is selected based on the optical design of the liquid crystal apparatus 100. Examples of the material of the alignment films 12 and 22 may include an inorganic compound such as silicon oxide and an organic compound such as polyimide.

The liquid crystal apparatus 100 employs a normally-white-mode or normally-black-mode optical design. In the normally white mode, the transmittance of each of the pixels P to which no voltage is applied is greater than the transmittance of the pixel P to which a voltage is applied. In the normally black mode, the transmittance of each of the pixels P to which no voltage is applied is smaller than the transmittance of the pixel P to which a voltage is applied. In the following description, it is assumed that the liquid crystal apparatus 100 employs the normally-black-mode optical design. Note that in accordance with the optical design of the liquid crystal apparatus 100, polarizers that are not shown are disposed in the spaces on opposite sides of the liquid crystal apparatus 100, the side on which the incident light L is incident and the side via which the incident light L exits.

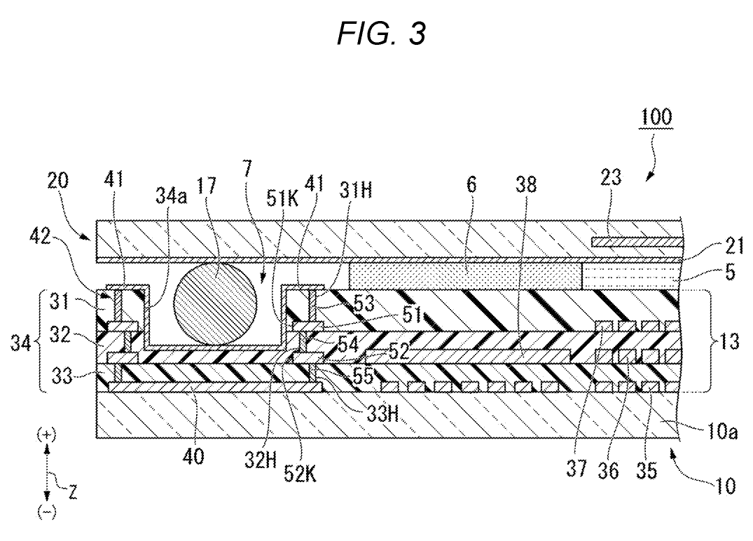

FIG. 3 is a cross-sectional view of the liquid crystal apparatus 100 taken along the line III-III shown in FIG. 1. FIG. 3 is a cross-sectional view showing the configuration of each of the inter-substrate conduction portions 7 and portions therearound.

The element substrate 10 includes, for example, a base 10a configured with a transparent substrate such as a glass substrate or a quartz substrate as a base material, a laminate 13 configured with an electrically conductive film and an insulating film provided on the base 10a, and the multiple pixel electrodes 11, as shown in FIG. 3. Note that the base 10a may include an electrically conductive film or an insulating film in addition to the transparent substrate.

The laminate 13 of the element substrate 10 includes an insulating member 34 including interlayer insulating films 31, 32, and 33, electrically conductive films 35, 36, and 37, a light blocking film 38, the wiring portion 40, conduction terminal portions 41, and relay electrode portions 42. Examples of the material of the interlayer insulating films 31, 32, and 33 may include silicon oxide (non-doped silicate glass: NSG) and silicon nitride. In the present embodiment, silicon oxide is employed.

The inter-substrate conduction portions 7 are each configured with the wiring portion 40, the conduction terminal portion 41, and the relay electrode portion 42 of the laminate 13. The inter-substrate conduction portion 7 together with the conduction member 17 cause the element substrate 10 and the counter substrate 20 to be electrically continuous with each other. The insulating member 34 has a recess 34a formed at a position where the recess 34a does not overlap with the relay electrode portion 42 in the plan view. The conduction member 17 is disposed at a position where the conduction member 17 overlaps with the recess 34a of the insulating member 34 in the plan view. The conduction member 17 is made of an electrically conductive paste containing multiple electrically conductive particles. Note that FIG. 3 is a simplified figure, shows the conduction member 17 as one spherical electrically conductive particle, but shows none of the alignment films 12 and 22 provided at the inner surfaces of the substrates 10 and 20, respectively.

The wiring portion 40 and the electrically conductive film 35 are formed on the base 10a. The wiring portion 40 is a portion of a common potential wire which is disposed outside the display region E and to which a common potential is applied. The electrically conductive film 35 includes, for example, capacitance wires, the scanning line drive circuits 45, and other wires. At least a portion of the scanning line drive circuits 45 contained in the electrically conductive film 35 is disposed in a region where the portion overlaps with the sealant 6 in the plan view. The interlayer insulating film (third interlayer insulating film) 33 is provided on the base 10a so as to cover the wiring portion 40 and the electrically conductive film 35.

The light blocking film 38 and the electrically conductive film 36 are formed on the +Z side of the interlayer insulating film 33. The light blocking film 38 is made, for example, of tungsten (W) or tungsten silicide (WSi), and blocks light incident on the scanning line drive circuits 45 contained in the electrically conductive film 35 to suppress malfunction of the scanning line drive circuits 45 due to stray light. The interlayer insulating film (second interlayer insulating film) 32 is layered on the +Z side of the interlayer insulating film 33 to cover the light blocking film 38 and the electrically conductive film 36.

The electrically conductive film 37 includes, for example, data lines or other wires. The interlayer insulating film (first interlayer insulating film) 31 is layered on the +Z side of the interlayer insulating film 32 to cover the electrically conductive film 37.

The multiple pixel electrodes 11 are formed on the +Z side of the interlayer insulating film 31, which is the outermost layer of the insulating member 34. The alignment film 12 is formed on the +Z side of the interlayer insulating film 31 to cover the multiple pixel electrodes 11.

The conduction terminal portion 41 is electrically coupled to the wiring portion 40. The conduction terminal portion 41 is configured with a transparent electrically conductive film such as an ITO or IZO film.

The relay electrode portion 42 relays electrical coupling between the wiring portion 40 covered with the insulating member 34 and the conduction terminal portion 41. The configuration of the relay electrode portion 42 will be described later.

The insulating member 34 has the recess 34a. The recess 34a is a hole formed in the insulating member 34 from the +Z side toward the −Z side thereof, and is formed to pass through the interlayer insulating film 31 and reach substantially the middle of the interlayer insulating film 32. The recess 34a is formed by etching the interlayer insulating films 31 and 32. The conduction member 17 is disposed at a position where the conduction member 17 overlaps with the recess 34a of the insulating member 34 in the plan view. Note that the depth of the recess 34a in the Z direction is set to any value by controlling the amount of the etching the interlayer insulating films 31 and 32.

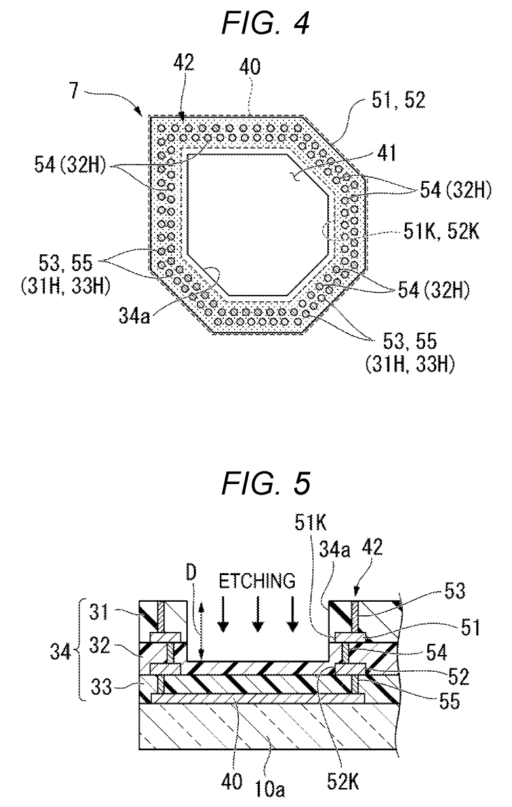

FIG. 4 is a plan view showing the planar configuration of each of the inter-substrate conduction portions 7. FIG. 4 does not show the conduction member 17 for clarity.

In the present embodiment, the wiring portion 40 and the recess 34a each, for example, have a heptagonal planar shape, and the recess 34a is formed in a region inside the wiring portion 40 concentrically therewith, as shown in FIG. 4. Note that the wiring portion 40 and the recess 34a do not necessarily have the planar shapes described above.

In the plan view, the recess 34a is formed at a position where the recess 34a does not overlap with the relay electrode portion 42. The relay electrode portion 42 is provided around the recess 34a and along the outer circumferential edge of the wiring portion 40. The conduction terminal portion 41 is provided along the recess 34a. The conduction terminal portion 41 is continuously formed, for example, by vapor deposition so as to extend from the surface of the interlayer insulating film 31 to the surface of the recess 34a (see FIG. 3).

The relay electrode portion 42 of the element substrate 10 includes an electrode film (first electrode film) 51, an electrode film (second electrode film) 52, multiple coupling members (first coupling member) 53, multiple coupling members (second coupling member) 54, and multiple coupling members (third coupling member) 55, as shown in FIG. 3.

The electrode film 51 is formed on the +Z-side surface of the interlayer insulating film 32. The electrode film 51 is covered with the interlayer insulating film 31. The electrode film 51 is formed in the same layer as the electrically conductive film 37. The electrode film 51 and the electrically conductive film 37 may be formed in the same patterning step or may be formed separately in different patterning steps. The electrode film 51 and the electrically conductive film 37 may be made of a common electrically conductive material or may be made of different electrically conductive materials.

An opening (first opening) 51K is provided in the electrode film 51. Note that a portion of the electrode film 51 may be cut off to provide a cutout in place of the opening 51K.

The opening 51K is formed at a position corresponding to the recess 34a, which passes through the interlayer insulating film 31. Specifically, the recess 34a is located in a region inside the opening 51K of the electrode film 51.

The opening 51K has a planar shape corresponding to the recess 34a. Specifically, the opening 51K has a heptagonal planar shape, and the recess 34a, the opening 51K, and the outer shape of the wiring portion 40 are concentric with each other. The configuration described above can avoid interference between the electrode film 51 and the recess 34a while minimizing the size of the opening 51K. The conduction reliability can therefore be improved by securing the contact area of the electrode film 51 with the coupling members 53, which will be described later, with an increase in the size of the electrode film 51 suppressed.

The coupling members 53 electrically couple the conduction terminal portion 41 to the electrode film 51. The coupling members 53 are embedded in the interlayer insulating film 31 in a region outside the recess 34a in the plan view. The coupling members 53 in the present embodiment are each configured with a tungsten plug made of tungsten (W) embedded in a contact hole 31H formed in the interlayer insulating film 31, which overlaps with the conduction terminal portion 41 and the electrode film 51 in the plan view.

The electrode film 52 is formed on the +Z-side surface of the interlayer insulating film 33. That is, the electrode film 52 is provided on a side of the electrode film 51 that is the side facing the wiring portion 40. The electrode film 52 is covered with the interlayer insulating film 32. The electrode film 52 is formed in the same layer as the light blocking film 38. The electrode film 52 and the light blocking film 38 may be formed in the same patterning step or may be formed separately in different patterning steps. The electrode film 52 and the light blocking film 38 may be made of a common electrically conductive material or may be made of different electrically conductive materials.

An opening 52K is provided in the electrode film 52. Note that a portion of the electrode film 52 may be cut off to provide a cutout in place of the opening 52K.

The opening 52K is formed at a position corresponding to the bottom of the recess 34a, which is formed in the interlayer insulating film 32. The opening 52K overlaps with the opening 51K of the electrode film 51 in the plan view. In the present embodiment, the opening 52K has the same shape, that is, the same size and shape as the opening 51K of the electrode film 51. In the present embodiment, the opening 52K has a heptagonal planar shape, and the recess 34a, the opening 51K, the opening 52K, and the outer shape of the wiring portion 40 are concentric with each other.

The configuration described above can avoid interference between the electrode film 52 and the recess 34a while minimizing the size of the opening 52K. The conduction reliability can therefore be improved by securing the contact area of the electrode film 52 with the coupling members 54, which will be described later, with an increase in the size of the electrode film 52 suppressed.

Note that the opening 52K and the opening 51K may differ in planar shape from each other as long as the entire opening 51K is located in the opening 52K in the plan view.

The coupling members 54 electrically couple the electrode film 51 to the electrode film 52. The coupling members 54 are disposed on the −Z side of the coupling members 53.

The coupling members 54 are embedded in the interlayer insulating film 32 in a region outside the recess 34a in the plan view. The coupling members 54 in the present embodiment are each configured with a tungsten plug made of tungsten (W) embedded in a contact hole 32H formed in the interlayer insulating film 32, which overlaps with the electrode films 51 and 52 in the plan view.

The wiring portion 40 is formed on the +Z-side surface of the base 10a. The wiring portion 40 is covered with the interlayer insulating film 33. The wiring portion 40 is formed in the same layer as the electrically conductive film 35. The wiring portion 40 and the electrically conductive film 35 may be formed in the same patterning step or may be formed separately in different patterning steps. The wiring portion 40 and the electrically conductive film 35 may be made of a common electrically conductive material or may be made of different electrically conductive materials.

The coupling members 55 electrically couple the electrode film 52 to the wiring portion 40. The coupling members 55 are disposed on the −Z side of the coupling members 54.

The coupling members 55 are embedded in the interlayer insulating film 33 in a region outside the recess 34a in the plan view. The coupling members 55 in the present embodiment are each configured with a tungsten plug made of tungsten (W) embedded in a contact hole 33H formed in the interlayer insulating film 33, which overlaps with the electrode film 52 and the wiring portion 40 in the plan view.

As described above, the element substrate 10 in the present embodiment, in which the coupling members 53, 54, and 55 in the relay electrode portion 42 are configured with the tungsten plugs, allows electrical coupling using the elongated plugs. The relay electrode portion 42 in the present embodiment therefore allows suppression of an increase in the planar area of the coupling members to reduce the size of the configuration of the entire apparatus.

The contact holes 31H and 32H are disposed at different positions where the two types of contact holes do not overlap with each other in the plan view, and the contact holes 32H and 33H are disposed at different positions where the two types of contact holes do not overlap with each other in the plan view, as shown in FIGS. 3 and 4. Note in the present embodiment that the contact holes 31H and 33H are disposed at the same positions where the two types of contact holes overlap with each other in the plan view, but may be disposed at different positions where the two types of contact holes do not overlap with each other.

Planarization such as CMP is performed on the coupling members 55, which each have the tungsten embedded structure, in the manufacturing process thereof, so that the coupling members 55 are formed so as to slightly enter the contact holes 33H. Therefore, the electrode film 52 has a substantially constant thickness, but enters the contact holes 33H at the portions where the electrode film 52 is coupled to the coupling members 55, so that the surface of the electrode film 52 is partially recessed, and there is therefore a concern that the flatness of the electrode film 52 partially decreases. Similarly, since the coupling members 54 slightly enter the contact holes 32H, the surface of the electrode film 51 may be recessed at the portions where the electrode film 51 is coupled to the coupling members 54, and there is therefore a concern that the flatness of the electrode film 51 partially decreases.

If the contact holes 33H and 32H are formed so as to overlap with each other in the plan view, the depth of the contact holes 32H in the Z direction undesirably increases, so that the reliability of the electrical coupling between the coupling members 54 and the electrode film 52 decreases. That is, a recess is undesirably formed in the surface of each of the coupling members 55 by the CMP performed when the coupling members 55 are formed in the contact holes 33H, so that the recesses are also reflected in the electrode film 52 formed at the recesses of the coupling members 55. As a result, the depth of the contact holes 32H in the Z direction undesirably increases, so that the possibility of conduction failure between the coupling members 54 and the electrode film 52 increases. The same applies to a case where the coupling members 54 and the coupling members 53 overlap with each other in the plan view. That is, the depth of the contact holes 31H in the Z direction undesirably increases, so that the reliability of the electrical coupling between the coupling member 53 and the electrode film 51 decreases.

In contrast, in the relay electrode portion 42 in the present embodiment, since the contact holes 31H, 32H, and 33H are disposed at positions where the three types of contact holes do not overlap with each other in the plan view as described above, the coupling members 53 and 54 can be formed at highly flat portions of the electrode films 51 and 52, respectively. The relay electrode portion 42 in the present embodiment therefore allows suppression of variation in the length of each of the coupling members 53 and 54 in the Z direction to improve the conduction reliability provided by the coupling members 53 and 54.

In the plan view, the multiple coupling members 53 are disposed so as to surround the outer edge of the recess 34a, and so are the multiple coupling members 54 and the multiple coupling members 55. That is, in the plan view, the multiple contact holes 31H are disposed so as to surround the outer edge of the recess 34a, and so are the multiple contact holes 32H and the multiple contact holes 33H. The relay electrode portion 42 in the present embodiment can therefore ensure the reliability of the conduction between the upper side and the lower side along the entire circumference of the recess 34a with the aid of the coupling members 53, 54, and 55.

In the present embodiment, the height of the conduction member 17 in the Z direction is greater than the depth of the recess 34a in the Z direction. The conduction member 17 disposed at a position where the conduction member 17 overlaps with the recess 34a of the insulating member 34 in the plan view therefore protrudes beyond the insulating member 34. Based on the configuration described above, the conduction member 17 is in contact with the conduction terminal portion 41 provided along the recess 34a on the −Z side, and is in contact with the counter electrode 21 provided at the inner surface of the counter substrate 20 on the +Z side. The conduction member 17 disposed in the recess 34a therefore allows the wiring portion 40 and the counter electrode 21 to be electrically continuous with each other via the conduction terminal portion 41.

The liquid crystal apparatus 100 according to the present embodiment includes the element substrate 10, the counter substrate 20, and the conduction members 17 provided between the element substrate 10 and the counter substrate 20. The element substrate 10 includes the electrode film 51 having the opening 51K, the insulating member 34 having the recess 34a provided in a region inside the opening 51K in the plan view, and the conduction terminal portions 41 each provided along the recess 34a of the insulating member 34 and electrically coupled to the conduction member 17.

In the liquid crystal apparatus 100 of the present embodiment, the conduction members 17 protruding from the insulating member 34 are in contact with the counter electrode 21, so that a cell gap that is the gap between the element substrate 10 and the counter substrate 20 is maintained at a predetermined value. The cell gap of the liquid crystal apparatus 100 is changed in some cases in accordance with optical characteristics according to the application and specifications of the liquid crystal apparatus 100.

In the liquid crystal apparatus 100 of the present embodiment, for example, the cell gap can be changed by adjusting the amount of protrusion of the conduction member 17 beyond the insulating member 34. Specifically, the amount of protrusion of the conduction member 17 beyond the insulating member 34 can be adjusted by changing the outer diameter of the electrically conductive particles contained in the conduction member, that is, by selecting a conduction member according to the cell gap.

However, when the conduction member having an outer diameter according to the cell gap is provided as described above, it takes time and effort to prepare multiple types of conduction members in accordance with the cell gap, which causes an increase in cost.

In contrast, in the liquid crystal apparatus 100 of the present embodiment, even when the common conduction member 17 is used, the amount of protrusion of the conduction member 17 beyond the insulating member 34 can be adjusted by adjusting the depth of the recess 34a in the Z direction.

FIG. 5 shows the step of forming the recess 34a. In the step of manufacturing the element substrate 10 in the present embodiment, a depth D of the recess 34a in the Z direction can be readily adjusted by controlling the amount of the etching the insulating member 34, as shown in FIG. 5.

The recess 34a is formed in the insulating member 34 at a position where the recess 34a overlaps with none of the electrode films 51 and 52, which constitute the relay electrode portion 42 in the plan view.

Specifically, the recess 34a is formed by etching the insulating member 34, which covers the inner side of the opening 51K of the electrode film 51 and the opening 52K of the electrode film 52. That is, the recess 34a is formed by etching the insulating member 34 that overlaps with none of the electrode film 51 and the electrode film 52. Note that the recess 34a can be formed to a depth at which the recess 34a does not expose the wiring portion 40 covered with the interlayer insulating film 33.

A case where the conduction members 17 each containing electrically conductive particles having a predetermined outer diameter are used will be presented by way of example below.

In the liquid crystal apparatus 100 of the present embodiment, the amount of protrusion of each of the conduction members 17 beyond the insulating member 34 can be reduced by increasing the depth of the recess 34a in the Z direction. The cell gap between the element substrate 10 and the counter substrate 20 can therefore be narrowed.

On the other hand, in the liquid crystal apparatus 100 of the present embodiment, the amount of protrusion of each of the conduction members 17 beyond the insulating member 34 can be increased by reducing the depth of the recess 34a in the Z direction. The cell gap between the element substrate 10 and the counter substrate 20 facing each other via the conduction members 17 having a predetermined outer diameter can therefore be increased.

As described above, according to the liquid crystal apparatus 100 of the present embodiment, adjusting the depth of the recess 34a formed in the element substrate 10 allows a predetermined cell gap to be set between the element substrate 10 and the counter substrate 20 even when the common conduction members 17 are used.

The liquid crystal apparatus 100 of the present embodiment, which does not require changing the type of the conduction members 17 in accordance with the requirement of the cell gap, therefore allows cost reduction by sharing the conduction members 17 even when employing various cell gaps.

### Second embodiment

A liquid crystal apparatus according to a second embodiment will be subsequently described. The present embodiment differs from the first embodiment in terms of the configurations of the element substrate, and the other elements are the same. The members common to those in the first embodiment therefore have the same reference characters and will not be described in detail.

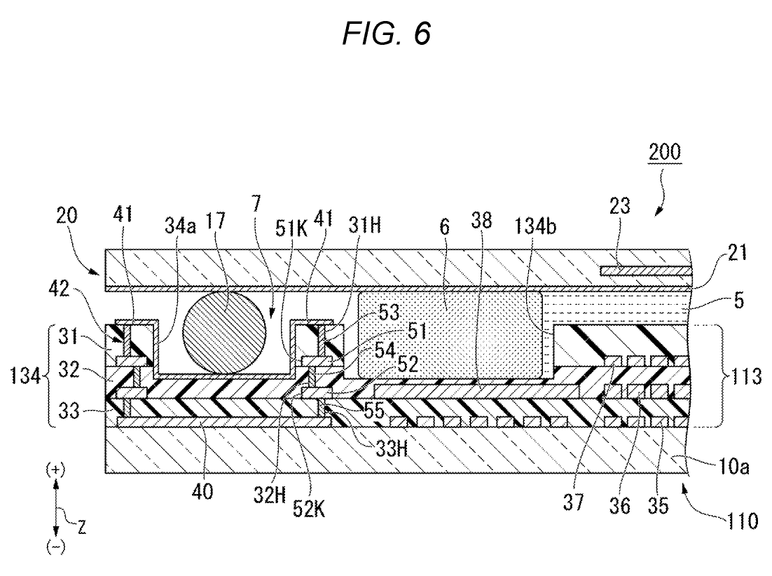

FIG. 6 is a cross-sectional view of a liquid crystal apparatus 200 of the present embodiment.

The liquid crystal apparatus 200 of the present embodiment includes an element substrate 110, the counter substrate 20, the liquid crystal layer 5, and the inter-substrate conduction portions 7, as shown in FIG. 6.

The element substrate 110 in the present embodiment includes the base 10a, a laminate 113 provided on the base 10a, and the multiple pixel electrodes 11. The laminate 113 includes an insulating member 134, the electrically conductive films 35, 36, and 37, the light blocking film 38, the wiring portions 40, the conduction terminal portions 41, and the relay electrode portions 42.

The insulating member 134 in the present embodiment includes the interlayer insulating films 31, 32, and 33, as the insulating member 34 in the first embodiment. The difference between the insulating member 134 and the insulating member 34 in the first embodiment is that the insulating member 134 further includes a sealant housing recess (second recess) 134b in addition to the recess 34a.

The sealant housing recess 134b is a hole formed in the insulating member 134 from the +Z side toward the −Z side thereof, and is formed to pass through the interlayer insulating film 31 and reach substantially the middle of the interlayer insulating film 32. The sealant housing recess 134b is formed in a region where the sealant housing recess 134b overlaps with the sealant 6 in the plan view. That is, the sealant housing recess 134b functions as a region that houses the sealant 6. The depth of the sealant housing recess 134b in the Z direction is set to any value by controlling the amount of the etching the interlayer insulating films 31 and 32, and can be formed at the maximum to a depth at which the sealant housing recess 134b does not expose the light blocking film 38.

In the present embodiment, the depth of the sealant housing recess 134b in the Z direction is equal to the depth of the recess 34a in the Z direction.

In the liquid crystal apparatus 100 of the first embodiment, when the cell gap is set to a predetermined value, it was possible to use the common conduction members 17 by adjusting the depth of the recess 34a in the Z direction. In the liquid crystal apparatus 100 of the first embodiment, the thickness of the sealant 6 also changes in accordance with the cell gap, so that it was necessary to change the type of the sealant 6 in accordance with the cell gap.

In contrast, according to the liquid crystal apparatus 200 of the present embodiment, the amount of protrusion of the sealant 6 beyond the sealant housing recess 134b can be adjusted by adjusting the depth of the sealant housing recess 134b in the Z direction.

In the liquid crystal apparatus 200 of the present embodiment, for example, when the depth of the sealant housing recess 134b in the Z direction is further increased, the amount of protrusion of the sealant 6 beyond the sealant housing recess 134b decreases. Therefore, even when the cell gap in the liquid crystal apparatus 200 is reduced, the gap between the element substrate 10 and the counter substrate 20 can be favorably sealed with the sealant 6 having the same thickness.

On the other hand, when the depth of the sealant housing recess 134b in the Z direction is reduced, the amount of protrusion of the sealant 6 beyond the sealant housing recess 134b increases. Therefore, even when the cell gap in the liquid crystal apparatus 200 is increased, the gap between the element substrate 10 and the counter substrate 20 can be favorably sealed with the sealant 6 having the same thickness.

The liquid crystal apparatus 200 of the present embodiment thus allows a predetermined cell gap to be set even when common members are used as the conduction members 17, as in the first embodiment. The liquid crystal apparatus 200 of the present embodiment further allows a predetermined cell gap to be set even when a common member is used as the sealant 6 in addition to the conduction members 17.

The liquid crystal apparatus 200 of the present embodiment therefore allows further cost reduction even when the cell gap varies by sharing the conduction members 17 and the sealant 6.

### Third embodiment

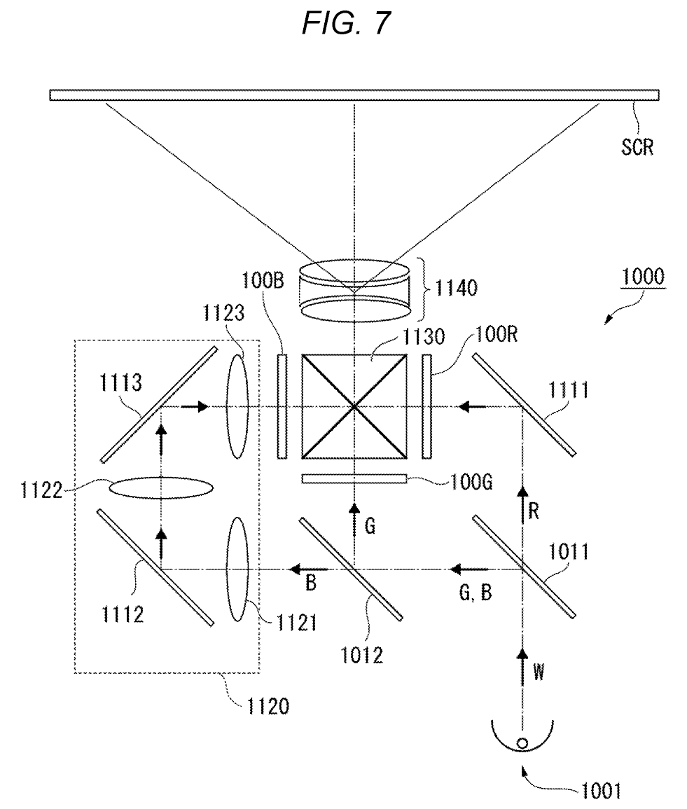

A third embodiment of the present disclosure will be subsequently described with reference to a projector 1000 by way of example of an electronic instrument including the liquid crystal apparatus 100. FIG. 7 is a schematic view of the projector 1000. The projector 1000 includes a light source apparatus 1001, dichroic mirrors 1011 and 1012, liquid crystal apparatuses 100B, 100G, and 100R, reflection mirrors 1111, 1112, and 1113, relay lenses 1121, 1122, and 1123, a cross dichroic prism 1130, and a projection lens 1140, as shown in FIG. 7.

The light source apparatus 1001 outputs white light W. The light source apparatus 1001 is, for example, a discharge-type lamp unit, but is not limited to a specific light source apparatus, and may be a light emitting diode, a laser, or the like or may be an apparatus that is a combination of a light emitter that emits blue light and a phosphor that converts part of the blue light emitted from the light emitter into yellow light and outputs the yellow light.

The white light W output from the light source apparatus 1001 is separated by the two dichroic mirrors 1011 and 1012 into three types of color light different in wavelength range from each other. The three types of color light include red light R, green light G, and blue light B. The dichroic mirror 1011 transmits the red light R and reflects the green light G and the blue light B shorter in wavelength than the red light R. The red light R passing through the dichroic mirror 1011 is reflected off the reflection mirror 1111 and enters the liquid crystal apparatus 100R. The green light G reflected off the dichroic mirror 1011 is reflected off the dichroic mirror 1012 and then enters the liquid crystal apparatus 100G. The blue light B reflected off the dichroic mirror 1011 passes through the dichroic mirror 1012 and exits to a relay lens system 1120.

The relay lens system 1120 includes the relay lenses 1121, 1122, and 1123 and the reflection mirrors 1112 and 1113. The optical path of the blue light B from the dichroic mirror 1011 to the liquid crystal apparatus 100B is longer than the optical path of the green light G from the dichroic mirror 1011 to the liquid crystal apparatus 100G and the optical path of the red light R from the dichroic mirror 1011 to the liquid crystal apparatus 100R. The luminous flux of the blue light B therefore tends to be larger than the luminous fluxes of the green light G and the red light R. Using the relay lens 1122 suppresses expansion of the luminous flux of the blue light B. The blue light B that enters the relay lens system 1120 is reflected off the reflection mirror 1112 and passes through the relay lens 1121, which causes the blue light B to converge in the vicinity of the relay lens 1122. The blue light B enters the liquid crystal apparatus 100B via the reflection mirror 1113 and the relay lens 1123.

The liquid crystal apparatuses 100R, 100G, and 100B are light modulators in the projector 1000. The liquid crystal apparatus 100 described above is used as each of the liquid crystal apparatuses 100R, 100G, and 100B.

The liquid crystal apparatuses 100R, 100G, and 100B are each electrically coupled to controllers external to the projector 1000. Image signals that specify the gradation levels of the red light R, the green light G, and the blue light B are supplied from the external controllers for the three types of color light, and are processed by integrated circuits associated with the liquid crystal apparatuses 100R, 100G, and 100B. The liquid crystal apparatuses 100R, 100G, and 100B are driven in accordance with the image signals received from the integrated circuits. The liquid crystal apparatus 100R modulates the red light R incident thereon. The liquid crystal apparatus 100G modulates the green light G incident thereon. The liquid crystal apparatus 100B modulates the blue light B incident thereon.

The red light R, the green light G, and the blue light B modulated by the liquid crystal apparatuses 100R, 100G, and 100B enter the cross dichroic prism 1130 in three directions. The cross dichroic prism 1130 is a light combining system in the projector 1000, and combines the red light R, the green light G, and the blue light B incident thereon with one another. The cross dichroic prism 1130 reflects and deflects the red light R and the blue light B by 90 degrees with respect to the respective incident directions, and transmits the green light G. As a result, the red light R, the green light G, and the blue light B combined with one another are output in the same direction. The red light R, the green light G, and the blue light B are combined with one another as display light used to display a color image, and output from the cross dichroic prism 1130 toward the projection lens 1140.

The projection lens 1140 is disposed so as to face the exterior of the projector 1000. The display light is enlarged and output via the projection lens 1140, and is projected onto a screen SCR, which is a projection target.

The projector 1000 according to the present embodiment includes, as the light modulators, the liquid crystal apparatuses, which each share the conduction members to achieve cost reduction even when the cell gap varies, and can therefore be a low-cost projector having desired optical characteristics.

In the present embodiment, the projector is presented by way of example of the electronic instrument, but the electronic instrument is not limited to a projector. The electronic instrument including the electro-optical apparatus according to an aspect of the present disclosure may, for example, be used in a projection-type head-up display, a direct-view head mounted display, a personal computer, a digital camera, and a liquid crystal television.

In the embodiments described above, the transmissive liquid crystal apparatuses are presented by way of example of the liquid crystal apparatuses as the electro-optical apparatus, and the electro-optical apparatus may be configured with reflective liquid crystal apparatuses or LCOS-type (liquid crystal on silicon) liquid crystal apparatuses. In addition, the electro-optical apparatus may be configured with organic EL apparatuses each having a layer made of an organic compound as an electro-optical layer, or may be configured with apparatuses each having an electro-optical layer other than liquid crystal apparatuses or organic EL apparatuses.

Note that the technical scope of the present disclosure is not limited to the embodiments described above, and various changes can be made thereto to the extent that the changes do not depart from the intent of the present disclosure.

For example, the first and second embodiments have been described with reference to the case where the relay electrode portions 42, which each relay the wiring portion 40 to the conduction terminal portion 41, each have three contact portions, but the configuration of the relay electrode portions 42 is not limited thereto. That is, the relay electrode portions may each have two contact portions, and in this case, the electrode film 51 and the wiring portion 40 are electrically coupled to each other by one contact portion. Still instead, a configuration in which the relay electrode portions each have four or more contact portions may be employed in accordance with the layer structure of the laminate 13.

### Summary of present disclosure

The present disclosure will be summarized below in the form of additional remarks.

### Additional Remark 1

An electro-optical apparatus including: a first substrate;
a second substrate; and
a conduction member provided between the first substrate and the second substrate,
wherein the first substrate includes
a first electrode film having an opening,
an insulating member having a first recess provided in a region inside the opening in a plan view, and
a conduction terminal portion provided along the first recess of the insulating member and electrically coupled to the conduction member.

According to the thus configured electro-optical apparatus, adjusting the depth of the recess formed in the insulating member of the first substrate allows a predetermined cell gap to be set between the first substrate and the second substrate even when a common member is used as the conduction member. The thus configured electro-optical apparatus, which does not require changing the type of the conduction member in accordance with the requirement of the cell gap, can therefore be an electro-optical apparatus having a cost reduced by sharing the conduction member even when the cell gap varies.

### Additional Remark 2

The electro-optical apparatus according to Additional Remark 1, wherein
the opening has a planar shape corresponding to the first recess.

The configuration described above can avoid interference between the first electrode film and the first recess while minimizing the size of the first opening. The conduction reliability can therefore be improved by securing the contact area of the first electrode film with the contact portion with an increase in the size of the first electrode film suppressed.

### Additional Remark 3

The electro-optical apparatus according to Additional Remark 2, further including:
a first interlayer insulating layer configured to cover the first electrode film and having a first contact hole used to electrically couple the conduction terminal portion to the first electrode film;
a second electrode film electrically coupled to the first electrode film;
a second interlayer insulating layer configured to cover the second electrode film and having a second contact hole used to electrically couple the first electrode film to the second electrode film;
a wiring portion to which a common potential is applied and which is electrically coupled to the second electrode film; and
a third interlayer insulating layer configured to cover the wiring portion and having a third contact hole used to electrically couple the second electrode film to the wiring portion.

The configuration described above can realize a structure in which the wiring portion covered with the insulating member configured with the three interlayer insulating films is electrically coupled to the conduction terminal portion.

### Additional Remark 4

The electro-optical apparatus according to Additional Remark 3, wherein
the first contact hole and the second contact hole are disposed at different positions in the plan view, and
the second contact hole and the third contact hole are disposed at different positions in the plan view.

The configuration described above allows formation of each of the contact holes in a highly flat portion of the corresponding electrode film. Variation in the length of each of the contact holes can therefore be suppressed, so that the conduction reliability can be improved.

### Additional Remark 5

The electro-optical apparatus according to Additional Remark 3 or 4, wherein
the first substrate includes a coupling member containing tungsten in each of the first, second, and third contact holes.

The configuration described above, in which the coupling member containing tungsten is provided in each of the contact holes to form a tungsten plug, allows electrical coupling using the elongated plugs. The relay electrode structure that electrically couples the wiring portion to the conduction terminal portion can therefore suppress an increase in the planar area of the contact portions to reduce the size of the configuration of the entire apparatus.

### Additional Remark 6

The electro-optical apparatus according to any one of Additional Remark 3 to 5, wherein
the multiple first contact holes, the multiple second contact holes, and the multiple third contact holes are disposed so as to surround an outer edge of the first recess in the plan view.

The configuration described above can realize a relay electrode structure in which the reliability of the conduction between the upper side and the lower side is ensured by the contact holes along the entire circumference of the recess.

### Additional Remark 7

The electro-optical apparatus according to any one of Additional Remarks 1 to 6, wherein
the second substrate includes a common electrode electrically coupled to the conduction terminal portion via the conduction member.

The configuration described above can realize a configuration in which the wiring portion of the first substrate and the common electrode of the second substrate are electrically coupled to each other via the common conduction member.

### Additional Remark 8

The electro-optical apparatus according to any one of Additional Remarks 1 to 7, further including
a sealant between the first substrate and the second substrate,
wherein the insulating member has a second recess formed in a region where the second recess overlaps with the sealant in the plan view.

The configuration described above allows a predetermined cell gap to be set between the first substrate and the second substrate even when a common member is used as the sealant.

### Additional Remark 9

An electronic instrument including
the electro-optical apparatus according to any one of Additional Remarks 1 to 8.

The thus configured electronic instrument, which includes the electro-optical apparatus including the shared conduction member to achieve cost reduction even when the cell gap varies, can be a low-cost electronic instrument having desired optical characteristics.

What is claimed is:

1. An electro-optical apparatus comprising:
a first substrate;
a second substrate; and
a conduction member provided between the first substrate and the second substrate,
wherein the first substrate includes:
a first electrode film having an opening,
an insulating member having a first recess provided in a region inside the opening in a plan view, and
a conduction terminal portion provided along the first recess of the insulating member and electrically coupled to the conduction member.

2. The electro-optical apparatus according to claim 1, wherein
the opening has a planar shape corresponding to the first recess.

3. The electro-optical apparatus according to claim 2, further comprising:
a second electrode film electrically coupled to the first electrode film; and
a wiring portion to which a common potential is applied and which is electrically coupled to the second electrode film; wherein
the insulating member includes:
a first interlayer insulating layer configured to cover the first electrode film and having a first contact hole used to electrically couple the conduction terminal portion to the first electrode film,
a second interlayer insulating layer configured to cover the second electrode film and having a second contact hole used to electrically couple the first electrode film to the second electrode film, and
a third interlayer insulating layer configured to cover the wiring portion and having a third contact hole used to electrically couple the second electrode film to the wiring portion.

4. The electro-optical apparatus according to claim 3, wherein
the first contact hole and the second contact hole are disposed at different positions in the plan view, and
the second contact hole and the third contact hole are disposed at different positions in the plan view.

5. The electro-optical apparatus according to claim 3, wherein
the first substrate includes a coupling member containing tungsten in each of the first, second, and third contact holes.

6. The electro-optical apparatus according to claim 3, wherein
the multiple first contact holes, the multiple second contact holes, and the multiple third contact holes are disposed so as to surround an outer edge of the first recess in the plan view.

7. The electro-optical apparatus according to claim 1, wherein
the second substrate includes a common electrode electrically coupled to the conduction terminal portion via the conduction member.

8. The electro-optical apparatus according to claim 1, further comprising
a sealant between the first substrate and the second substrate,
wherein the insulating member has a second recess formed in a region where the second recess overlaps with the sealant in the plan view.

9. An electronic instrument comprising
the electro-optical apparatus according to claim 1.
